(19) United States
(12) Patent Application Publication
(10) Pub. No.: US 2021/0291837 A1
(43) Pub. Date: Sep. 23, 2021

(54) CONCENTRATION DEGREE DETERMINATION DEVICE, CONCENTRATION DEGREE DETERMINATION METHOD, AND PROGRAM FOR DETERMINING CONCENTRATION DEGREE

(71) Applicant: OMRON Corporation, Kyoto-shi, Kyoto (JP)

(72) Inventors: Tomoyoshi AIZAWA, Kyoto-shi (JP); Hiroshi SUGAHARA, Kyoto-shi (JP); Kazuyoshi OKAJI, Kyoto-shi (JP); Michie UNO, Kyoto-shi (JP); Koji TAKIZAWA, Kyoto-shi (JP)

(73) Assignee: OMRON Corporation, Kyoto-shi, KYOTO (JP)

(21) Appl. No.: 16/334,377

(22) PCT Filed: Oct. 25, 2017
(86) PCT No.: PCT/JP2017/038562

§ 371 Date: Mar. 19, 2019

(30) Foreign Application Priority Data
Mar. 14, 2017 (JP) 2017-048192

(51) Int. Cl. B60W 40/08; B60W 50/14; B60W 40/06; B60W 30/08

(52) U.S. Cl. CPC B60W 40/08; B60W 50/14; B60W 40/06; B60W 2552/05; B60W 2040/0827; B60W 2420/42; B60W 2540/22; B60W 30/08

(57) ABSTRACT

A concentration degree determination device includes: a monitoring data acquisition unit configured to acquire monitoring data from a sensor that monitors a driver; a concentration degree estimator configured to estimate a driving concentration degree of the driver from the monitoring data; a reference comparator configured to compare the driving concentration degree to a first-road reference when a vehicle is running on a first road, and to compare the driving concentration degree to a second-road reference when the vehicle is running on a second road; and a signal output unit configured to output an instruction signal issuing an instruction to perform support to the driver after elapse of a first time when the driving concentration degree does not satisfy the first-road reference, and to output the instruction signal after elapse of a second time shorter than the first time when the driving concentration degree does not satisfy the second-road reference.

### TECHNICAL FIELD

The present invention relates to a concentration degree determination device that determines a concentration degree of a driver of a vehicle, a concentration degree determination method, and a program for determining the concentration degree.

### BACKGROUND ART

In recent years, in addition to a manual driving mode in which a vehicle is caused to run based on a driving operation of a driver, an automatic driving mode in which the vehicle is caused to run along a previously-set route regardless of the driving operation of the driver has been developed as an driving mode of a vehicle.

A cruise control technique according to an environment in which the vehicle is running has also been developed (see Japanese Patent No. 4600542).

### SUMMARY OF THE INVENTION

Although drivers are required to secure driving safety regardless of the driving mode, driving concentration degree required for the driver varies according to a situation in which the driver is placed. The driving safety is maintained when the vehicle constantly monitors the driving concentration degree of the driver by a strict reference and issues a warning when the driving concentration degree falls below the reference. However, the vehicle frequently issues an alarm depending on the situation in which the driver is placed. In this case, driving comfort of the driver is impaired.

The present invention has been made in view of the above circumstances, and an object of the present invention is to provide a concentration degree determination device, a concentration degree determination method, and a program for determining the concentration degree for allowing both the driving safety and the driving comfort to be considered.

In order to solve the above problem, according to a first aspect of the present invention, a concentration degree determination device includes: a monitoring data acquisition unit configured to acquire monitoring data from a sensor that monitors a driver of a vehicle; a concentration degree estimator configured to estimate a driving concentration degree of the driver from the monitoring data; a reference comparator configured to compare the driving concentration degree to a first-road reference when the vehicle is running on a first road, and to compare the driving concentration degree to a second-road reference when the vehicle is running on a second road having a road environment different from a road environment of the first road; and a signal output unit configured to output an instruction signal issuing an instruction to perform support to the driver after elapse of a first time when the driving concentration degree does not satisfy the first-road reference during running of the vehicle on the first road, and to output the instruction signal after elapse of a second time shorter than the first time when the driving concentration degree does not satisfy the second-road reference during running of the vehicle on the second road.

According to a second aspect of the present invention, in the concentration degree determination device of the first aspect, the first road is an expressway and the second road is an ordinary road.

According to a third aspect of the present invention, in the concentration degree determination device of the first aspect, the concentration degree estimator estimates the driving concentration degree with at least one of sleepiness and looking aside of the driver as an index.

According to a fourth aspect of the present invention, in the concentration degree determination device of the first aspect, the signal output unit changes at least one of a length of the first time and a length of the second time according to an index used to estimate the driving concentration degree.

According to a fifth aspect of the present invention, in the concentration degree determination device of the first aspect, the signal output unit performs at least one of not outputting the instruction signal when the driving concentration degree satisfies the first-road reference within the first time even if the driving concentration degree is determined not to satisfy the first-road reference during the running of the vehicle on the first road and not outputting the instruction signal when the driving concentration degree satisfies the second-road reference within the second time even if the driving concentration degree is determined not to satisfy the second-road reference during the running of the vehicle on the second road.

According to a sixth aspect of the present invention, a concentration degree determination method includes: a monitoring data acquisition step of acquiring monitoring data from a sensor that monitors a driver of a vehicle; a concentration degree estimating step of estimating a driving concentration degree of the driver from the monitoring data; a reference comparing step of comparing the driving concentration degree to a first-road reference when the vehicle is running on a first road, and of comparing the driving concentration degree to a second-road reference when the vehicle is running on a second road having a road environment different from a road environment of the first road; and a signal output step of outputting an instruction signal issuing an instruction to perform support to the driver after elapse of a first time when the driving concentration degree does not satisfy the first-road reference during running of the vehicle on the first road, and of outputting the instruction signal after elapse of a second time shorter than the first time when the driving concentration degree does not satisfy the second-road reference during running of the vehicle on the second road.

According to a seventh aspect of the present invention, a program for determining concentration degree, the program causes a computer to execute processing of each unit included in the concentration degree determination device according to any one of the first aspect to the fifth aspect.

According to the first aspect of the present invention, the concentration degree determination device can quickly output the instruction signal because the case that the vehicle is running on the second road (for example, the road on which the concentration and attention are required for the driving of the vehicle as compared with the first road) has a higher degree of urgency of the warning than as compared with the case that the vehicle is running on the first road. In the case that the vehicle is running on the second road, the driver can recognize the decrease in driving concentration degree by the warning based on the instruction signal more quickly than the case that the vehicle is running on the first road, and enhance the driving concentration degree. Thus, the driving safety is maintained regardless of the road environment in which the vehicle is running.

Additionally, according to the first aspect, in the case that the vehicle is running on the first road, the concentration degree determination device can output the instruction signal after the elapse of the first time longer than the second time. In the case that the output of the instruction signal is not required by the event generated before the elapse of the first time, the concentration degree determination device can reduce the output of the excessive instruction signal during the running of the vehicle on the first road. The driver does not receive the excessive warning in the case that the vehicle is running on the first road, so that the driver comfortably maintains the state of concentrating on the driving regardless of the road environment in which the vehicle is running. Thus, the driving comfort is maintained irrespective of the road environment in which the vehicle is running.

That is, according to the first aspect, the concentration degree determination device can consider both the driving safety and the driving comfort.

According to the second aspect of the present invention, in the case that the vehicle is running on the ordinary road, the concentration degree determination device can require the driver to have the higher driving concentration degree as compared with the case that the vehicle is running on the expressway. Consequently, the driver can maintain the state of concentrating on the driving even on the ordinary road on which the concentration and attention are required for the driving as compared with the expressway. The concentration degree determination device can decrease the output of excessive instruction signal particularly in the case that the vehicle is running on the expressway. In the case that the vehicle is running on the expressway, the driver does not need the warning as compared with the case that the vehicle is running on the ordinary road. For this reason, in the case that the vehicle is running on the expressway, the driver does not receive the excessive warning, and can comfortably drive the vehicle.

According to the third aspect of the present invention, the concentration degree determination device can monitor whether the driver is in the state suitable for the driving using the index, such as sleepiness and looking aside, which has the large influence on the driving safety regardless of the road environment in which the vehicle is running. Consequently, the driver can maintain the state of concentrating on the driving regardless of the road environment in which the vehicle is running.

According to a fourth aspect of the present invention, the concentration degree determination device can output the instruction signal at a speed corresponding to a degree of urgency of the warning for each index in at least one of the case that the vehicle is running on the first road and the case that the vehicle is running on the second road. The driver can receive the warning in proper timing, so that the driver can properly maintain the state suitable for the road environment.

According to the fifth aspect of the present invention, the concentration degree determination device can stop the output of the unnecessary instruction signal in at least one of the case that the vehicle is running on the first road and the case that the vehicle is running on the second road. The concentration degree determination device can reduce the output of the excessive instruction signal. The driver does not receive the excessive warning in the case that the vehicle is running on the first road, so that the driver can comfortably maintain the state of concentrating on the driving. Even if the concentration degree determination device stops the output of the instruction signal, the driving concentration degree is recovered so as to satisfy the reference. Thus, the driving safety is maintained.

According to the sixth aspect of the present invention, the concentration degree determination method can obtain the same effect as the first aspect. That is, the concentration degree determination method can consider both the driving safety and the driving comfort.

According to the seventh aspect of the present invention, the program for determining the concentration degree can obtain the same effect as the first aspect. That is, the program for determining the concentration degree can consider both the driving safety and the driving comfort.

### BRIEF DESCRIPTION OF THE DRAWINGS

FIG. 1 is a view illustrating an overall configuration of a vehicle including a concentration degree determination device according to an embodiment of the present invention.

FIG. 2 is a block diagram illustrating a configuration of the concentration degree determination device of the embodiment of the present invention.

FIG. 3 is a block diagram illustrating a configuration of a state detector of the embodiment of the present invention.

FIG. 4 is a flowchart illustrating a procedure of concentration degree determination made by the concentration degree determination device in FIG. 2.

### MODE FOR CARRYING OUT THE INVENTION

An embodiment of the present invention will be described below with reference to the drawings.

### Embodiment

### (Configuration)

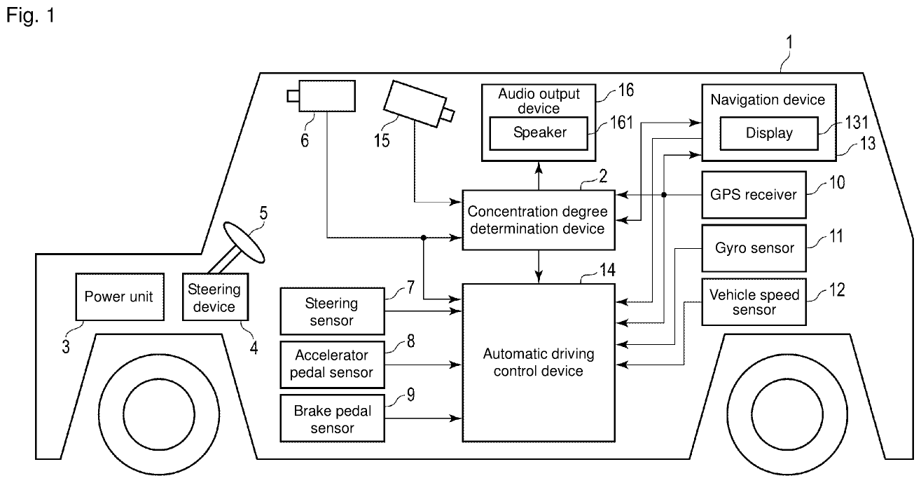

FIG. 1 is a view illustrating an overall configuration of a vehicle 1 including a concentration degree determination device 2 of an embodiment of the present invention. The concentration degree determination device 2 is mounted on the vehicle 1 such as a passenger car. A configuration of the concentration degree determination device 2 will be described later. For example, the vehicle 1 may be any one of a car, a bus, a truck, a train, and the like, or other vehicles on which a driver rides.

The vehicle 1 includes a power unit 3 including a power source and a speed change device and a steering device 4 equipped with a steering wheel 5 as basic equipment, and has a manual driving mode and an automatic driving mode as a driving mode. An engine, a motor, or both are used as the power source.

For example, the manual driving mode is a mode in which the vehicle 1 is mainly caused to run by a manual driving operation of the driver. For example, the manual driving mode includes an operating mode in which the vehicle 1 is caused to run based only on the driving operation of the driver and an operating mode in which driving operation support control to support the driving operation of the driver is performed while the driving operation of the driver is mainly performed.

For example, the driving operation support control assists steering torque such that steering of the driver becomes a proper steering amount based on a curvature of a curve when the vehicle 1 is running on the curve. The driving operation support control also includes control to support an accelerator operation (for example, an operation of an accelerator pedal) or a brake operation (for example, an operation of a brake pedal) of the driver, manual steering (manual driving of the steering), and manual speed adjustment (manual driving of speed adjustment). In the manual steering, the driver mainly operates the steering wheel 5 to steer the vehicle 1. In the manual speed adjustment, the speed of the vehicle 1 is adjusted mainly by accelerator operation or brake operation by the driver.

The driving operation support control does not include control to forcibly intervene the driving operation of the driver to cause the vehicle 1 to run automatically. That is, the manual driving mode includes control to reflect the driving operation of the driver in the running of the vehicle 1 within a previously-set allowable range, but does not include control to forcibly intervene the running of the vehicle 1 under a certain condition (for example, lane departure of the vehicle 1).

On the other hand, for example, the automatic driving mode is a mode in which a driving state in which the vehicle 1 is cause to run automatically along a running road of the vehicle 1 is performed. For example, the automatic driving mode includes a driving state in which the driver causes the vehicle 1 to run automatically toward a previously-set destination without performing the driving operation. In the automatic driving mode, the whole control of the vehicle 1 is not necessarily automatically performed. The automatic driving mode also includes a driving state in which the driving operation of the driver is reflected in the running of the vehicle 1 within a previously-set allowable range. That is, the automatic driving mode includes control to reflect the driving operation of the driver in the running of the vehicle 1 within the previously-set allowable range, and to forcibly intervene the running of the vehicle 1 under a certain condition.

The vehicle 1 further includes an external camera 6, a steering sensor 7, an accelerator pedal sensor 8, a brake pedal sensor 9, a GPS receiver 10, a gyro sensor 11, a vehicle speed sensor 12, a navigation device 13, an automatic driving control device 14, a driver camera 15, and an audio output device 16.

The external camera 6 is installed at any position of the vehicle 1 so as to capture an image of an outside of the vehicle 1. Although one external camera 6 is illustrated in FIG. 1, the vehicle 1 may include a plurality of external cameras that capture images in different directions. The external camera 6 continuously captures the image of a running environment in a vicinity of the vehicle 1. The external camera 6 is activated in response to start of driving of the vehicle 1, and continuously captures the image of the outside of the vehicle 1. The external camera 6 outputs the captured image (hereinafter, also referred to as “external image data”) to the concentration degree determination device 2 and the automatic driving control device 14.

The steering sensor 7 detects a steering angle. The steering sensor 7 outputs a detection result to the automatic driving control device 14.

The accelerator pedal sensor 8 detects an operation amount of the accelerator pedal. The accelerator pedal sensor 8 outputs the detection result to the automatic driving control device 14.

The brake pedal sensor 9 detects the operation amount of the brake pedal. The brake pedal sensor 9 outputs the detection result to the automatic driving control device 14.

The GPS receiver 10 receives current position information about the vehicle 1. The GPS receiver 10 outputs the current position information to the concentration degree determination device 2, the navigation device 13, and the automatic driving control device 14.

The gyro sensor 11 detects a behavior of the vehicle 1. The gyro sensor 11 outputs the detection result to the automatic driving control device 14.

The vehicle speed sensor 12 detects speed of the vehicle 1. The vehicle speed sensor 12 outputs the detection result to the automatic driving control device 14.

The navigation device 13 is an example of a video display device including a display 131 that displays video. The navigation device 13 stores map information. The navigation device 13 extracts route information from a current position to a destination using information about the destination input by the driver or the like, the map information, and the current position information from the GPS receiver 10. The navigation device 13 displays the route information on the display 131. The navigation device 13 can also display information except for the route information on the display 131.

The navigation device 13 outputs the route information to the concentration degree determination device 2 and the automatic driving control device 14.

The route information may include not only information about a route from the current position to the destination but also information about a road environment from the current position to the destination.

Some examples of the information about the road environment will be described.

The information about the road environment may include information about a type of road through which the vehicle 1 passes from the current position to the destination. For example, the type of the road is divided into a road on which passage of a person is restricted and a road on which the passage of the person is not restricted. For example, the road on which the passage of the person is restricted is an expressway. The expressway means a national expressway and a superhighway. For example, the road on which the passage of the person is not restricted is an ordinary road. The ordinary road means a road except for the expressway.

The information about the road environment may include information about a speed limit of the road through which the vehicle 1 passes from the current position to the destination.

The information about the road environment may include position information about an installed object on the road through which the vehicle 1 passes from the current position to the destination. For example, the installed object is a sign, or may be an object installed on the road.

The information about the road environment may include the position information about the building in the vicinity of the road through which the vehicle 1 passes from the current position to the destination.

The route information may include information except for the above example as information about the road environment.

The configuration of the automatic driving control device 14 will be described.

The automatic driving control device 14 automatically controls the running of the vehicle 1 when the driving mode is the automatic driving mode.

The automatic driving control device 14 acquires the external image data from the external camera 6, the detection result from the steering sensor 7, the detection result from the accelerator pedal sensor 8, the detection result from the brake pedal sensor 9, the current position information from the GPS receiver 10, the detection result from the gyro sensor 11, the detection result from the vehicle speed sensor 12, and the route information from the navigation device 13. For example, the automatic driving control device 14 automatically controls the running of the vehicle 1 based on these pieces of information and traffic information acquired by road-to-vehicle communication.

For example, automatic control includes automatic steering (automatic driving of the steering) and automatic speed adjustment (automatic driving of the speed). The automatic steering is a driving state in which the steering device 4 is automatically controlled. The automatic steering includes a lane keeping assist system (LKAS). The LKAS automatically controls the steering device 4 such that the vehicle 1 does not deviate from a driving lane, for example, even if the driver does not perform the steering operation. Even during the performance of the LKAS, the steering operation of the driver may be reflected on the steering of the vehicle 1 within a range (allowable range) in which the vehicle 1 does not deviate from the driving lane. The automatic steering is not limited to the LKAS.

The automatic speed adjustment is a driving state in which the speed of the vehicle 1 is automatically controlled. The automatic speed adjustment includes adaptive cruise control (ACC). For example, the ACC performs constant speed control causing the vehicle 1 to run at a constant speed and at a previously-set speed in the case that a preceding vehicle does not exist in front of the vehicle 1, and the ACC performs follow-up control adjusting the vehicle speed of the vehicle 1 according to an inter-vehicle distance to the preceding vehicle in the case that the preceding vehicle exists in front of the vehicle 1. The automatic driving control device 14 decelerates the vehicle 1 in response to the brake operation (for example, the operation of the brake pedal) of the driver even while the ACC is currently performed. Even if the ACC is currently performed, the automatic driving control device 14 can accelerate the vehicle 1 in response to the accelerator operation (for example, the operation of the accelerator pedal) of the driver up to a previously-set maximum permissible speed (for example, a legally-defined maximum speed on the road on which the vehicle is running). The automatic speed adjustment is not limited to not only the ACC but also cruise control (CC: constant speed control).

The configuration of the driver camera 15 will be described.

For example, the driver camera 15 is installed at a position, such as on a dashboard, which faces a front of the driver. The driver camera 15 is an example of a sensor that monitors the driver. The driver camera 15 is activated in response to the start of the driving of the vehicle 1, and continuously captures an image of a predetermined range including a face of the driver. The driver camera 15 outputs the captured image (hereinafter, referred to as driver image data) to the concentration degree determination device 2. The driver image data is an example of monitoring data used to detect the state of the driver. For example, the state of the driver includes at least one of indices such as front gazing of a driver, sleepiness, looking aside, putting-on and taking-off of clothes, a telephone operation, leaning against a window side or an armrest, driving interference by a passenger or a pet, onset of a disease, back-facing, lying face down, eating and drinking, smoking, dizziness, an abnormal behavior, a car navigation or audio operation, putting-on and taking-off of glasses or sunglasses, image capturing, and a recognition degree (object recognition degree) with respect to an object. The object recognition degree is an index how much the driver recognizes an object (for example, visually), and is a degree to which the driver consciously confirms (for example, visually) an object. The state of the driver may include an index except for the indices exemplified here.

The audio output device 16 includes a speaker 161. The audio output device 16 outputs various pieces of information by sound.

The configuration of the concentration degree determination device 2 will be described.

The concentration degree determination device 2 estimates a driving concentration degree of the driver based on the state of the driver and determines whether the driver is suitable for driving the vehicle 1. The driving concentration degree is a degree to which the driver is suitable for the driving of the vehicle 1. With increasing driving concentration degree, the driver becomes more suitable for the driving of the vehicle 1. On the other hand, with decreasing driving concentration degree, the driver becomes under a condition that the driver is not suitable for the driving of the vehicle 1.

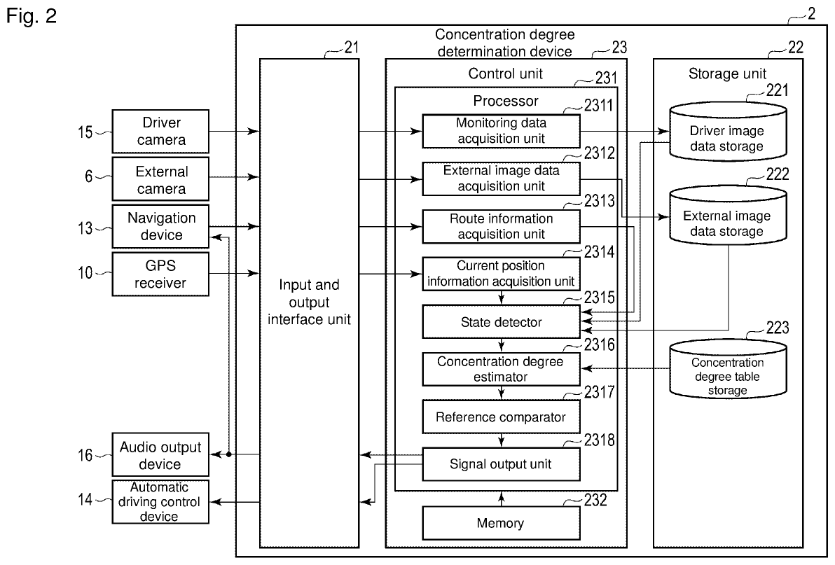

FIG. 2 is a block diagram illustrating the configuration of the concentration degree determination device 2 as an example.

The concentration degree determination device 2 includes an input and output interface unit 21, a storage unit 22, and a control unit 23.

The input and output interface unit 21 connects each of the external camera 6, the GPS receiver 10, the navigation device 13, the automatic driving control device 14, the driver camera 15, and the audio output device 16 to the control unit 23.

The configuration of the storage unit 22 will be described.

The storage unit 22 is a nonvolatile memory, such as a solid state drive (SSD) and a hard disk drive (HDD), in which writing and reading can be performed at any time. The storage unit 22 includes a driver image data storage 221, an external image data storage 222, and a concentration degree table storage 223.

The driver image data storage 221 stores the driver image data that is acquired from the driver camera 15 by the control unit 23.

The external image data storage 222 stores the external image data that is acquired from the external camera 6 by the control unit 23.

The concentration degree table storage 223 stores a concentration degree table that is used by the control unit 23 to estimate the driving concentration degree. For each index, the concentration degree table correlates the state of the driver while dividing the state of the driver into a plurality of degrees according to the driving concentration degree. For example, the plurality of degrees are divided into three levels of a level 1, a level 2, and a level 3. However, the present invention is not limited to this configuration. At this point, an example in which the driving concentration degree is set lower as the level number increases will be described. However, the present invention is not limited to this example. The driving concentration degree may be set higher as the level number increases.

Information managed in the concentration degree table will be described by taking looking aside as an example.

The concentration degree table correlates the state of the driver with the level 1, the level 2, and the level 3 with respect to the looking aside as an index. For example, the level 1 is correlated with the state of the driver who looks at a direction inclined at an angle within the range greater than or equal to 0 degrees and less than a first angle with respect to a traveling direction of the vehicle 1. That is, the level 1 is a state in which the driver is not looking aside but has the high driving concentration degree. For example, the level 2 is correlated with the state of the driver who looks at the direction inclined at an angle within a range greater than or equal to the first angle and less than a second angle with respect to the traveling direction of the vehicle 1. That is, the level 2 is a state, in which the driver is slightly looking aside and the driving concentration degree is lower than that of the level 1. For example, the level 3 is correlated with the state of the driver who looks at the direction inclined at an angle within the range greater than or equal to the second angle with respect to the traveling direction of the vehicle 1. That is, the level 3 is a state, in which the driver is looking aside and the driving concentration degree is lower than that of the level 2. In this case, the information managed in the concentration degree table is described by taking the looking aside as an example. The same holds true for other indices.

The configuration of the control unit 23 will be described.

The control unit 23 includes a processor 231 and a memory 232.

For example, the processor 231 is a central processing unit (CPU) constituting a computer. The configuration of each unit of the processor 231 will be described later. Although one processor 231 is illustrated in FIG. 2, the control unit 23 may include at least one processor.

The memory 232 is provided with a program causing the processor 231 to function as processing of each unit of the processor 231. The program can also be referred to as an instruction to operate the processor 231. The program is stored in the storage unit 22, and read from the storage unit 22 to the memory 232. The program of the memory 232 is read by the processor 231. One embodiment may be implemented by the program.

The configuration of each unit of the processor 231 will be described.

The processor 231 includes a monitoring data acquisition unit 2311, an external image data acquisition unit 2312, a route information acquisition unit 2313, a current position information acquisition unit 2314, a state detector 2315, a concentration degree estimator 2316, a reference comparator 2317, and a signal output unit 2318. Each unit may be distributed to at least one processor.

The monitoring data acquisition unit 2311 acquires the driver image data from the driver camera 15 through the input and output interface unit 21. The monitoring data acquisition unit 2311 stores the driver image data in the driver image data storage 221.

The external image data acquisition unit 2312 acquires the external image data from the external camera 6 through the input and output interface unit 21. The external image data acquisition unit 2312 stores the external image data in the external image data storage 222.

The route information acquisition unit 2313 acquires the route information from the navigation device 13 through the input and output interface unit 21. The route information acquisition unit 2313 outputs the route information to the state detector 2315.

The current position information acquisition unit 2314 acquires the current position information from the GPS receiver 10 through the input and output interface unit 21. The current position information acquisition unit 2314 outputs the current position information to the state detector 2315.

The state detector 2315 detects the state of the driver from the driver image data stored in the driver image data storage 221. In addition to the driver image data, the state detector 2315 may detect the object recognition degree as the state of the driver using at least one of the external image data, the route information, and the current position information. A detection example of the state of the driver by the state detector 2315 will be described later. The state detector 2315 may acquire the driver image data from the monitoring data acquisition unit 2311 with no use of the driver image data storage 221. In this case, the storage unit 22 may not include the driver image data storage 221.

The state detector 2315 outputs the state of the driver to the concentration degree estimator 2316.

The concentration degree estimator 2316 estimates the driving concentration degree of the driver based on the state of the driver detected by the state detector 2315. The state of the driver is detected from the driver image data as described above, so that the concentration degree estimator 2316 can also estimate the driving concentration degree of the driver from the driver image data.

The concentration degree estimator 2316 estimates the driving concentration degree based on at least one index included in the state of the driver. For example, the concentration degree estimator 2316 may estimate the driving concentration degree corresponding to each of the plurality of indices. For example, the concentration degree estimator 2316 estimates the driving concentration degree using the sleepiness as an index, and also estimates the driving concentration degree with the looking aside as an index. For example, the concentration degree estimator 2316 may estimate the single driving concentration degree based on the plurality of indices. In this case, the concentration degree estimator 2316 may estimate the single driving concentration degree by appropriately setting a weight to each index. The weight set to each index may be arbitrarily changeable.

In one example, the concentration degree estimator 2316 can estimate the driving concentration degree using a numerical value such as a ratio. The numerical value estimated by the concentration degree estimator 2316 may increase with increasing driving concentration degree, or decrease with increasing driving concentration degree.

In another example, the concentration degree estimator 2316 can refer to the concentration degree table stored in the concentration degree table storage 223, and estimate the level of the driving concentration degree corresponding to the state of the driver from the plurality of levels. In the case that the concentration degree estimator 2316 estimates the driving concentration degree using the numerical value, the storage unit 22 may not include the concentration degree table storage 223.

The driving concentration degree may be estimated by the concentration degree estimator 2316 using an artificial intelligence (AI) function such as machine learning and deep learning. In this case, for example, the concentration degree estimator 2316 can accurately estimate the state of the driver by utilizing the past estimation result in the estimation of the current driving concentration degree.

The configuration of the reference comparator 2317 will be described.

The reference comparator 2317 determines the road environment in which the vehicle 1 is running in order to compare the driving concentration degree estimated by the concentration degree estimator 2316 to a reference. For example, the reference comparator 2317 determines the road environment in which the vehicle 1 is running as described below. For example, the reference comparator 2317 can determine the road environment of the road on which the vehicle 1 is running based on the route information from the navigation device 13. For example, the reference comparator 2317 may determine the road environment of the road on which the vehicle 1 is running based on the information obtained by road-to-vehicle communication. The reference comparator 2317 may determine the road environment of the road on which the vehicle 1 is running based on information except for these pieces of information. The reference comparator 2317 determines the road environment of the road on which the vehicle 1 is running, which allows the reference comparator 2317 to determine whether the vehicle 1 is running on a first road or a second road having a different road environment from that of the first road.

Examples of the first road and the second road will be described. For example, the second road is a road having the road environment in which the driver needs more concentration and attention to drive the vehicle 1 as compared with the first road. The second road may be a road having the different road environment from that of the first road as described above, and is not limited to this example.

Some examples in which the second road is the road having the road environment in which the driver needs more concentration and attention to drive the vehicle 1 as compared with the first road will be described below, but the present invention is not limited to these examples.

In one example, the first road is an expressway and the second road is an ordinary road. Usually people cannot jump out on the expressway. On the other hand, people can jump out on the ordinary roads. The expressway is a road having a straight line section longer than that of the ordinary road. For this reason, in the ordinary road, irrespective of the driving mode, the driver needs more concentration and attention to drive the vehicle 1 as compared with the expressway.

In another example, the first road is a road section including an intersection where a signal is installed among the ordinary roads, and the second road is a road section including an intersection where the signal is not installed among the ordinary roads. At the intersection where the signal is installed, there is a low possibility that people jump out. On the other hand, at the intersection where the signal is not installed, there is a high possibility that people jump out. For this reason, in the road section including the intersection where the signal is not installed, irrespective of the driving mode, the driver needs more concentration and attention to drive the vehicle 1 as compared with the road section including the intersection where the signal is installed.

The reference comparator 2317 compares the driving concentration degree estimated by the concentration degree estimator 2316 to the reference. The reference comparator 2317 compares the driving concentration degree estimated by the concentration degree estimator 2316 to a first-road reference in the case that the vehicle 1 is running on the first road. For example, the reference comparator 2317 compares the driving concentration degree estimated by the concentration degree estimator 2316 to a first-road reference value or a first-road reference level, which becomes the first-road reference. When the driving concentration degree is greater than or equal to the first-road reference value or the first-road reference level, the reference comparator 2317 determines that the driving concentration degree satisfies the first-road reference.

The reference comparator 2317 compares the driving concentration degree estimated by the concentration degree estimator 2316 to a second-road reference in the case that the vehicle 1 is running on the second road having the road environment different from that of the first road. For example, the reference comparator 2317 compares the driving concentration degree estimated by the concentration degree estimator 2316 to a second-road reference value or a second-road reference level, which becomes the second-road reference. When the driving concentration degree is greater than or equal to the second-road reference value or the second-road reference level, the reference comparator 2317 determines that the driving concentration degree satisfies the second-road reference.

A reference for the automatic driving mode and a reference for the manual driving mode may be a common reference or different references.

In the case that the concentration degree estimator 2316 estimates the driving concentration degree with respect to each of the plurality of indices, the reference comparator 2317 may compare the driving concentration degree with respect to each of the plurality of indices to the reference. In the case that the concentration degree estimator 2316 estimates the single driving concentration degree based on the plurality of indices, the reference comparator 2317 compares the single driving concentration degree to the reference. The reference comparator 2317 outputs the comparison result to the signal output unit 2318. The reference may be arbitrarily changeable.

The comparison between the driving concentration degree estimated by the reference comparator 2317 using the numerical value and the reference will be described as an example.

The case that the numerical value estimated by the concentration degree estimator 2316 increases with increasing driving concentration degree will be described below. The reference value is set to a numerical value A. When the numerical value estimated by the concentration degree estimator 2316 is smaller than the numerical value A that is the reference value, the reference comparator 2317 determines that the driving concentration degree estimated by the concentration degree estimator 2316 is lower than the reference value.

The case that the numerical value estimated by the concentration degree estimator 2316 decreases with increasing driving concentration degree will be described below. When the numerical value estimated by the concentration degree estimator 2316 is larger than the numerical value A that is the reference value, the reference comparator 2317 determines that the driving concentration degree estimated by the concentration degree estimator 2316 is lower than the reference value.

The comparison between the driving concentration degree estimated at the level by the reference comparator 2317 and the reference will be described as another example.

The reference level is set to a level B extracted from a plurality of levels. In the case that the driving concentration degree lower than the level B that is the reference level is assigned to the level estimated by the concentration degree estimator 2316, the reference comparator 2317 determines that the driving concentration degree estimated by the concentration degree estimator 2316 is lower than the reference level.

An example in which the concentration degree table correlates the state of the driver with each index while dividing the state of the driver into three levels of the level 1, the level 2, and the level 3 will specifically be described. For example, the reference level is set to the level 1. The reference comparator 2317 determines that the level 2 or level 3 estimated by the concentration degree estimator 2316 is lower than the level 1 that is the reference level. On the other hand, the reference comparator 2317 determines that the level 1 estimated by the concentration degree estimator 2316 is not lower than the level 1 that is the reference level.

The configuration of the signal output unit 2318 will be described.

The signal output unit 2318 outputs a signal to each unit through the input and output interface unit 21. Examples of some signals output from the signal output unit 2318 will be described below.

Based on the comparison result from the reference comparator 2317, the signal output unit 2318 determines whether to output an instruction signal instructing the performance of the support to the driver to a support providing device. In the case that the driving concentration degree estimated by the concentration degree estimator 2316 does not satisfy the first-road reference while the vehicle 1 is running on the first road, the signal output unit 2318 outputs the instruction signal after a first time elapses. On the other hand, when the driving concentration degree estimated by the concentration degree estimator 2316 does not satisfy the second-road reference while the vehicle 1 is running on the second road, the signal output unit 2318 outputs the instruction signal after a second time shorter than the first time elapses. Upon receiving the instruction signal from the signal output unit 2318, the support providing device performs predetermined support to the driver. For example, the support providing device is the navigation device 13 or the audio output device 16.

An example of counting of the first time or the second time by the signal output unit 2318 will be described. For example, the signal output unit 2318 may start the counting of the first time or the second time from the time the reference comparator 2317 determines that the driving concentration degree does not satisfy the reference. For example, the signal output unit 2318 may start the counting of the first time or the second time from the time the signal output unit 2318 receives the comparison result indicating that the driving concentration degree does not satisfy the reference from the reference comparator 2317. The timing at which the signal output unit 2318 starts the counting of the first time or the second time is not limited to these, and may be from any time.

A length of the first time or the second time is not limited. For example, the first time may be about four seconds to about ten seconds, and the second time may be about one second to about two seconds.

For example, the signal output unit 2318 outputs the instruction signal to at least one of the navigation device 13 and the audio output device 16. Based on the instruction signal, the navigation device 13 displays a warning giving attention to the driver on the display 131 as an image or video. Based on the instruction signal, the audio output device 16 outputs the warning giving the attention to the driver from the speaker 161 as a sound. The warning is not limited to a specific output mode, as long as the warning is a content that gives the attention to the driver, for example, that the driving concentration degree is low or that it is necessary to concentrate on the driving. The driver can recognize that the driver is not in the state suitable for the driving of the vehicle 1 by the warning, and concentrate on the driving of the vehicle 1 again. The signal output unit 2318 may output the instruction signal to the support providing device except for the navigation device 13 and the audio output device 16. The signal output unit 2318 may output the instruction signal to the support providing device that gives an external stimulus such as vibration to the driver. The support to the driver is not limited as long as the support is the output content acting on the driver based on the driving concentration degree, and includes various kinds of support to encourage improvement of the driving concentration degree in addition to the warning, call for attention, and information provision.

The signal output unit 2318 can output the instruction signal when at least one driving concentration degree out of a plurality of driving concentration degrees estimated from a plurality of indices does not satisfy the reference. The signal output unit 2318 may output the instruction signal when at least a predetermined number of driving concentration degrees out of the plurality of driving concentration degrees estimated from the plurality of indices does not satisfy the reference. The signal output unit 2318 may output the instruction signal when the single driving concentration degree estimated based on the plurality of indices does not satisfy the reference.

The signal output unit 2318 may output a switching signal switching the driving mode to the automatic driving control device 14. For example, in the case that the output condition of the instruction signal is satisfied in the manual driving mode, the signal output unit 2318 may output the instruction signal while outputting the switching signal switching the driving mode from the manual driving mode to the automatic driving mode to the automatic driving control device 14.

A detection example of the state of the driver using the driver image data by the state detector 2315 will be described below. A method of detecting the state of the driver is not limited to the example described below.

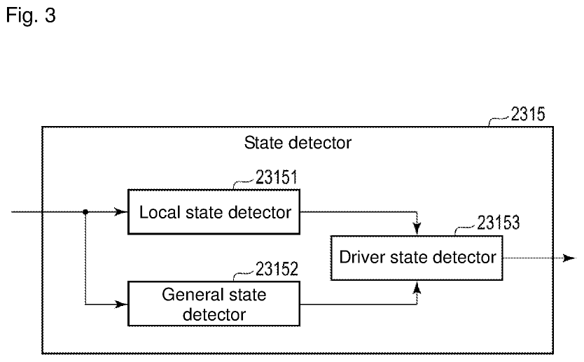

FIG. 3 is a block diagram illustrating the configuration of the state detector 2315. For example, the state detector 2315 includes a local state detector 23151, a general state detector 23152, and a driver state detector 23153.

The local state detector 23151 detects the state of at least one of organs included in a face of the driver in the driver image data. Examples of the organs included in the face include eyes, a mouth, a nose, and ears. In the case that the local state detector 23151 detects the state of the eyes, for example, the local state detector 23151 detects a degree of opening and closing of the eyes of the driver, a direction of a line of sight, an orientation of the face, and the like. The local state detector 23151 outputs the detection result (hereinafter, also referred to as local information) to the driver state detector 23153.

The general state detector 23152 detects at least one state out of the general states of the driver in the driver image data. Examples of the general states include the operation and the attitude of the driver. The general state detector 23152 outputs the detection result (hereinafter, also referred to as general information) to the driver state detector 23153.

The driver state detector 23153 detects the state of the driver using the local information from the local state detector 23151 and the general information from the general state detector 23152.

In this way, for example, by combining the local information and the general information, the state detector 2315 can detect various states of the driver.

Some detection examples of the object recognition degree by the state detector 2315 will be described below. The state detector 2315 can detect the object recognition degree using the monitoring data and the position information about the object.

By way of example, the state detector 2315 can detect the following object recognition degree by a visual sense of the driver using the external image data in addition to the driver image data. The state detector 2315 extracts the object from the external image data in order to detect the object recognition degree. For example, the object is an installed object such as a sign or a building, but the object is not particularly limited as long as the object has a possibility of being consciously (for example, visually) recognized by the driver. The state detector 2315 detects the line of sight and the orientation of the face of driver from the driver image data captured at substantially the same timing as the timing of capturing the external image data from which the object is extracted. The line of sight and the orientation of the face of the driver are detected by the local state detector 23151 as described above. The state detector 2315 detects the object recognition degree using at least one of the line of sight and the orientation of the face of the driver and the position information about the object. The object recognition degree increases as the line of sight and the orientation of the face of the driver are directed toward the object.

Some examples in which the level of the object recognition degree is detected by the state detector 2315 will be described below.

In one example, the state detector 2315 may detect that the object recognition degree is high on the condition that at least one of the line of sight and the orientation of the face of the driver is maintained for a predetermined time while matched with the position of the object. On the other hand, in the case that the driver passes through the object without recognizing the object while at least one of the line of sight and the orientation of the face of the driver is directed toward the object, the state detector 2315 may detect that the object recognition degree is low. The state detector 2315 may detect the object recognition degree according to the length of time during which at least one of the line of sight and the orientation of the face of the driver is maintained while matched with the position of the object.

In another example, the state detector 2315 may estimate the object recognition degree based on an assumed specific driving operation generated as a result of recognition of the object by the driver or the presence or absence of the operation of the driver. For example, when the driver recognizes that a pedestrian exists near a pedestrian crossing in front of the vehicle 1, it is assumed that the driver performs a deceleration operation. In the case that the concentration degree determination device 2 detects that the pedestrian exists near the pedestrian crossing in front of the vehicle 1, when the state detector 2315 may detect that the object recognition degree is high when the deceleration operation of the driver is detected. On the other hand, in the case that the concentration degree determination device 2 detects that the pedestrian exists near the pedestrian crossing in front of the vehicle 1, the state detector 2315 may detect that the object recognition degree is low when the deceleration operation of the driver cannot be detected even after a predetermined time elapses. For example, the state detector 2315 may detect the object recognition degree according to the length of time since the concentration degree determination device 2 detects the pedestrian that is the object until the concentration degree determination device 2 detects the deceleration operation of the driver.

As another example, using the route information and the current position information in addition to the driver image data, the state detector 2315 can detect the object recognition degree as follows.

The state detector 2315 refers to the route information and the current position information, and extracts the object located in the vicinity of the vehicle 1. As described above, for example, the object is the installed object such as the sign or the building, but the object is not particularly limited as long as the object has a possibility of being consciously (for example, visually) recognized by the driver. The state detector 2315 detects the line of sight and the orientation of the face of the driver from the driver image data captured at substantially the same timing as the timing at which the vehicle 1 passes in the vicinity of the object. The state detector 2315 detects the object recognition degree using at least one of the line of sight and the orientation of the face of the driver and the position information about the object.

As another example, the state detector 2315 may obtain the position of the object and the timing at which the vehicle 1 passes in the vicinity of the object by road-to-vehicle communication. In this case, the state detector 2315 detects the line of sight and the orientation of the face of the driver from the driver image data captured at substantially the same timing as the timing at which the vehicle 1 passes in the vicinity of the object. The state detector 2315 detects the object recognition degree using at least one of the line of sight and the orientation of the face of the driver and the position information about the object.

As another example, the state detector 2315 may use the image or video displayed on the display 131 of the navigation device 13 as the object. In this case, the state detector 2315 detects the line of sight and the orientation of the face of the driver from driver image data captured at substantially the same timing as the timing of displaying the image or video on the display 131. The state detector 2315 detects the object recognition degree using at least one of the line of sight and the orientation of the face of the driver and the position information about the object.

Using at least the monitoring data and the position information about the object as described above, the state detector 2315 can properly detect the state of the driver with the object recognition degree as the index.

The state detector 2315 may use the object located in the vicinity of the front, rear, left, or right side of the vehicle 1. Preferably the state detector 2315 uses the object located in the vicinity of the left or right side of the vehicle 1 as compared with the front side of the vehicle 1. The line of sight and the face of the driver do not move so much when the object is located on the front side of the vehicle 1. On the other hand, when the object is located in the vicinity of the left or right side of the vehicle 1, the line of sight and the face of the driver move to the left or right side. Consequently, the state detector 2315 can properly detect the object recognition degree.

(Operation)

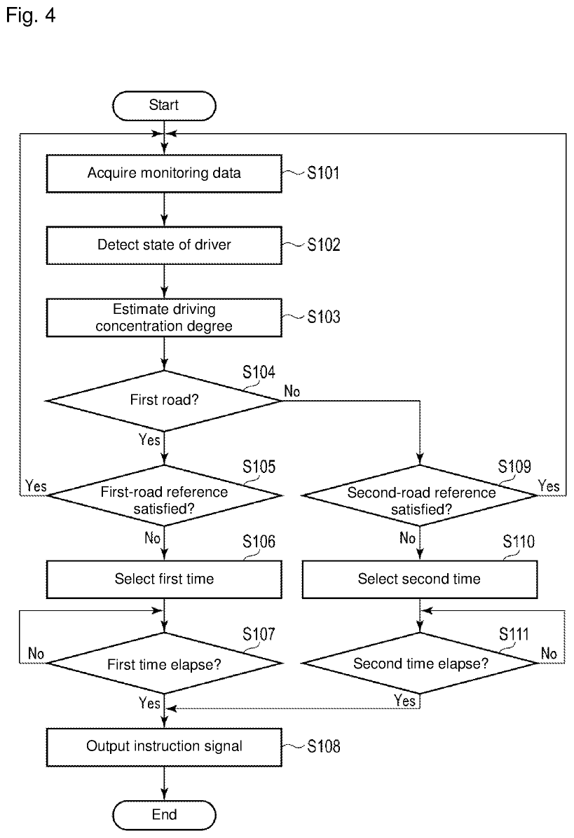

The operation of the concentration degree determination device 2 configured as described above will be described below. FIG. 4 is a flowchart illustrating a procedure as an example of the concentration degree determination made by the concentration degree determination device 2. The operation of the concentration degree determination device 2 may be similar regardless of whether the driving mode is the automatic driving mode or the manual driving mode.

The monitoring data acquisition unit 2311 acquires monitoring data from a sensor that monitors the driver of the vehicle 1 (step S101). In step S101, for example, the monitoring data acquisition unit 2311 acquires the driver image data from the driver camera 15 through the input and output interface unit 21. An interval at which the monitoring data acquisition unit 2311 acquires the monitoring data may be equal to or shorter than an interval at which the state detector 2315 detects the state of the driver.

Subsequently, the state detector 2315 detects the state of the driver from the monitoring data (step S102). In step S102, for example, the state detector 2315 detects the state of the driver from the driver image data. For example, the state detector 2315 can detect the state of the driver at predetermined constant intervals. The state detector 2315 may detect the state of the driver at different intervals even if the state of the driver is detected at the same interval between the automatic driving mode and the manual driving mode. The state detector 2315 may detect the state of the driver at the same interval or at different intervals between the case that the vehicle 1 is running on the first road and the case that the vehicle 1 is running on the second road. The state detector 2315 may detect the state of the driver in any timing.

Subsequently, the concentration degree estimator 2316 estimates the driving concentration degree of the driver from the monitoring data (step S103). In step 103, for example, the concentration degree estimator 2316 estimates the driving concentration degree based on the state of the driver detected from the driver image data by the state detector 2315.

The reference comparator 2317 determines whether the vehicle 1 is running on the first road (step S104). When the vehicle 1 is running on the first road (Yes in step S104), the reference comparator 2317 compares the driving concentration degree to the first-road reference (step S105). When the driving concentration degree satisfies the first-road reference (Yes in step S105), the processing of the concentration degree determination device 2 may transition from step S105 to step S101. When the driving concentration degree does not satisfy the first-road reference (No in step S105), the signal output unit 2318 selects the first time as the time until the instruction signal is output (step S106).

The signal output unit 2318 starts the counting of the first time, and determines whether the first time elapses (step S107). For example, in the case that the reference comparator 2317 determines that the driving concentration degree for each of the plurality of indices does not satisfy the first-road reference, the signal output unit 2318 can start the counting of the first time for each index. For example, in the case that the reference comparator 2317 determines that the driving concentration degree for each of the plurality of indices does not satisfy the first-road reference in different timing, the signal output unit 2318 can start the counting of the first time in different timing for each index. When the first time does not elapse (No in step S107), the signal output unit 2318 continues to count the first time, and continues to monitor the elapse of the first time.

When the first time elapses (Yes in step S107), the signal output unit 2318 outputs the instruction signal (step S108). That is, in step S108, in the case that the driving concentration degree does not satisfy the first-road reference while the vehicle 1 is running on the first road, the signal output unit 2318 outputs the instruction signal after the first time elapses.

When the vehicle 1 is not running on the first road (No in step S104), the reference comparator 2317 compares the driving concentration degree to the second-road reference (step S109). At this point, the case that the vehicle 1 is not running on the first road corresponds to the case that the vehicle 1 is running on the second road. When the driving concentration degree satisfies the second-road reference (Yes in step S109), the processing of the concentration degree determination device 2 may transition from step S109 to step S101. When the driving concentration degree does not satisfy the second-road reference (No in step S109), the signal output unit 2318 selects the second time as the time until the instruction signal is output (step S110).

The signal output unit 2318 starts the counting of the second time, and determines whether the second time elapses (step S111). For example, in the case that the reference comparator 2317 determines that the driving concentration degree for each of the plurality of indices does not satisfy the second-road reference, the signal output unit 2318 can start the counting of the second time for each index. For example, in the case that the reference comparator 2317 determines that the driving concentration degree for each of the plurality of indices does not satisfy the second-road reference in different timing, the signal output unit 2318 can start the counting of the second time in different timing for each index. When the second time does not elapse (No in step S111), the signal output unit 2318 continues to count the second time, and continues to monitor the elapse of the second time.

When the second time elapses (Yes in step S111), the signal output unit 2318 outputs the instruction signal (step S108). That is, in step S108, in the case that the driving concentration degree does not satisfy the second-road reference while the vehicle 1 is running on the second road, the signal output unit 2318 outputs the instruction signal after the second time elapses.

In step S105, the signal output unit 2318 may determine the second road as a road on which the concentration and attention are required for the driving of the vehicle 1 as compared with the first road. The case that the first road is the expressway while the second road is the ordinary road will be described as an example, but the same holds true for other examples. In the case that the vehicle 1 is running on the ordinary road, the concentration degree determination device 2 can require the driver to have the higher driving concentration degree as compared with the case that the vehicle 1 is running on the expressway. Consequently, the driver can maintain the state of concentrating on the driving even on the ordinary road on which the concentration and attention are required for the driving as compared with the expressway. The concentration degree determination device 2 can decrease the output of excessive instruction signal particularly in the case that the vehicle 1 is running on the expressway. In the case that the vehicle 1 is running on the expressway, the driver does not need the warning as compared with the case that the vehicle 1 is running on the ordinary road. In the case that the vehicle 1 is running on the expressway, the driver does not receive the excessive warning, and can comfortably drive the vehicle 1.

In the case that the first road is the expressway while the second road is the ordinary road, a predetermined section in the expressway may be excluded from the first road. That is, the reference comparator 2317 does not necessarily need to apply the reference (for example, the first-road reference) different from the ordinary road in all the sections of the expressway. In the predetermined section of the expressway, the reference comparator 2317 may apply the reference equivalent to that of the ordinary road (for example, the second-road reference). Examples of the predetermined section include an entrance and exit of the expressway, a tollgate, and a section within a predetermined distance with a junction as a starting point.

The index with which the concentration degree estimator 2316 estimates the driving concentration degree in step S103 is not particularly limited, but the concentration degree estimator 2316 may estimate the driving concentration degree with at least one of the sleepiness and the looking aside of the driver as an index. The sleepiness and the looking aside are indices that have a large influence on the driving safety. The concentration degree determination device 2 can monitor whether the driver is in the state suitable for the driving using the index having the large influence on the driving safety regardless of the road environment in which the vehicle 1 is running. Consequently, the driver can maintain the state of further concentrating on the driving regardless of the road environment in which the vehicle 1 is running.

(Effect)

As described above in detail, in the embodiment of the present invention, the concentration degree determination device 2 can quickly output the instruction signal because the case that the vehicle 1 is running on the second road (for example, the road on which the concentration and attention are required for the driving of the vehicle 1 as compared with the first road) has a higher degree of urgency of the warning as compared with the case that the vehicle 1 is running on the first road.

The effect will be described from the viewpoint of the driving safety.

The case that the vehicle 1 is running on the second road will be described. When the vehicle 1 does not quickly issue the warning, the driver cannot immediately notice a decrease in driving concentration degree. Thus, in the case that the driving concentration degree when the vehicle 1 is running on the second road does not satisfy the second-road reference, the degree of urgency of the warning is higher as compared with the case that the vehicle 1 is running on the first road.

The case that the vehicle 1 is running on the first road will be described. Even if the vehicle 1 does not quickly issue the warning, the concentration and attention are not required for the driving of the vehicle 1 on the first road as compared with the second road. Thus, in the case that the driving concentration degree when the vehicle 1 is running on the first road does not satisfy the first-road reference, the degree of urgency of the warning is lower as compared with the case that the vehicle 1 is running on the second road.

In this way, in the case that the vehicle 1 is running on the second road, the driver can recognize the decrease in driving concentration degree by the warning more quickly than the case that the vehicle 1 is running on the first road, and enhance the driving concentration degree. Thus, the driving safety is maintained regardless of the road environment in which the vehicle 1 is running.

In the case that the vehicle 1 is running on the first road, the concentration degree determination device 2 can output the instruction signal after the elapse of the first time longer than the second time.

The effect will be described from the viewpoint of the driving comfort.

In the case that the vehicle 1 is running on the second road, even if the vehicle 1 frequently issues the warning, there is a low possibility that the driver recognizes that the driver is excessively warned. When the vehicle 1 frequently issues the warning in the case that the vehicle 1 is running on the first road, there is a high possibility that the driver recognizes that the driver is excessively warned. However, for example, the concentration degree determination device 2 may not need to output the instruction signal depending on an event generated before the elapse of the first time correlated with the first road.

In one example, in the case that the vehicle 1 arrives at the destination before the elapse of the first time, the concentration degree determination device 2 does not need to output the instruction signal. In another example, in the case that stop of the warning is input when the vehicle 1 is running on the first road, the concentration degree determination device 2 does not need to output the instruction signal. In another example, in the case that the driving concentration degree satisfies the reference before the elapse of the first time, the concentration degree determination device 2 does not need to output the instruction signal. The examples of several events are described above, but the present invention is not limited thereto.

In this way, the concentration degree determination device 2 can reduce the output of the excessive instruction signal in the case that the vehicle 1 is running on the first road. The driver does not receive the excessive warning in the case that the vehicle 1 is running on the first road, so that the driver comfortably maintains the state of concentrating on the driving regardless of the road environment in which the vehicle 1 is running. Thus, the driving comfort is maintained irrespective of the road environment in which the vehicle 1 is running.

In one embodiment, the concentration degree determination device 2 can consider both the driving safety and the driving comfort.

### OTHER EMBODIMENTS

Other embodiments will be described below.

The signal output unit 2318 may monitor whether the output of the instruction signal is necessary according to the driving concentration degree during a period from the start of the counting of the first time to the elapse of the first time.

In one example, the signal output unit 2318 may not output the instruction signal in the case that the driving concentration degree satisfies (recovers) the first-road reference within the first time even if the driving concentration degree is determined not to satisfy the first-road reference during the running of the vehicle 1 on the first road. The signal output unit 2318 may be configured so as not to output the instruction signal in the case that the driving concentration degree satisfies the first-road reference within the first time. For example, the signal output unit 2318 may stop the output of the instruction signal by stopping the counting of the first time. For example, the signal output unit 2318 may directly stop the output of the instruction signal. For example, during the processing of step S107 in FIG. 4, the signal output unit 2318 may detect that the driving concentration degree satisfies the first-road reference within the first time based on the comparison result from the reference comparator 2317. In the case that the signal output unit 2318 stops the output of the instruction signal, the processing of the concentration degree determination device 2 may transition from step S107 to step S101 in FIG. 4.

For example, it is assumed that the car navigation and audio operation is the state of the driver that can be generated even if the vehicle 1 is running on the first road. However, the car navigation and audio operation is a temporary operation by the driver. The driving concentration degree for the car navigation and audio operation has a high possibility that the driving concentration degree satisfies the first-road reference immediately even if the driving concentration degree does not temporarily satisfy the first-road reference. For this reason, the warning relating to the car navigation and audio operation is unnecessary for the driver.

In this example, the concentration degree determination device 2 can stop the output of the unnecessary instruction signal. The concentration degree determination device 2 can reduce the output of the excessive instruction signal in the case that the vehicle 1 is running on the first road. The driver does not receive the excessive warning in the case that the vehicle 1 is running on the first road, so that the driver can comfortably maintain the state of concentrating on the driving. Even if the concentration degree determination device 2 stops the output of the instruction signal, the driving concentration degree is recovered so as to satisfy the first-road reference. Thus, the driving safety is maintained in the case that the vehicle 1 is running on the first road.

In another example, the signal output unit 2318 may output the instruction signal after the elapse of the first time in the case that the driving concentration degree does not continuously satisfy the first-road reference during the first time. For example, during the processing of step S107 in FIG. 4, the signal output unit 2318 may detect that the driving concentration degree does not continuously satisfy the first-road reference during the first time based on the comparison result from the reference comparator 2317.

In this example, the concentration degree determination device 2 can output the necessary instruction signal after the elapse of the first time. Even if the vehicle 1 is running on the first road in order to maintain the driving safety, the driver needs to maintain the driving concentration degree such that the driving concentration degree satisfies the first-road reference. The driver can recognize the decrease in driving concentration degree by the warning, and enhance the driving concentration degree. Thus, the driving safety is maintained in the case that the vehicle 1 is running on the first road. The warning is necessary for the driver whose driving concentration degree does not continuously satisfy the first-road reference during the first time. The driver does not receive the excessive warning in the case that the vehicle 1 is running on the first road, so that the driver can comfortably maintain the state of concentrating on the driving.

The signal output unit 2318 may monitor whether the output of the instruction signal is necessary according to the driving concentration degree during a period from the start of the counting of the second time to the elapse of the second time.

In one example, the signal output unit 2318 may not output the instruction signal in the case that the driving concentration degree satisfies (recovers) the second-road reference within the second time even if the driving concentration degree is determined not to satisfy the second-road reference during the running of the vehicle 1 on the second road. The signal output unit 2318 may be configured so as not to output the instruction signal in the case that the driving concentration degree satisfies the second-road reference within the second time. For example, the signal output unit 2318 may stop the output of the instruction signal by stopping the counting of the second time. For example, the signal output unit 2318 may directly stop the output of the instruction signal. For example, during the processing of step S111 in FIG. 4, the signal output unit 2318 may detect that the driving concentration degree satisfies the second-road reference within the second time based on the comparison result from the reference comparator 2317. In the case that the signal output unit 2318 stops the output of the instruction signal, the processing of the concentration degree determination device 2 may transition from step S111 to step S101 in FIG. 4.

For example, it is assumed that the putting-on and taking-off of glasses or sunglasses are the state of the driver that can be generated even if the vehicle 1 is running on the second road. However, the putting-on and taking-off of the glasses or sunglasses are a temporary operation by the driver. The driving concentration degree for the putting-on and taking-off of the glasses or sunglasses has a high possibility that the driving concentration degree satisfies the second-road reference immediately even if the driving concentration degree does not temporarily satisfy the second-road reference. For this reason, the warning relating to the putting-on and taking-off of the glasses or sunglasses is unnecessary for the driver.

In this example, the concentration degree determination device 2 can stop the output of the unnecessary instruction signal. The concentration degree determination device 2 can reduce the output of the excessive instruction signal in the case that the vehicle 1 is running on the second road. The driver does not receive the excessive warning in the case that the vehicle 1 is running on the second road, so that the driver can comfortably maintain the state of concentrating on the driving. Even if the concentration degree determination device 2 stops the output of the instruction signal, the driving concentration degree is recovered so as to satisfy the second-road reference. Thus, the driving safety is maintained in the case that the vehicle 1 is running on the second road.

In another example, the signal output unit 2318 may output the instruction signal after the elapse of the second time in the case that the driving concentration degree does not continuously satisfy the second-road reference during the second time. For example, during the processing of step S111 in FIG. 4, the signal output unit 2318 may detect that the driving concentration degree does not continuously satisfy the second-road reference during the second time based on the comparison result from the reference comparator 2317.

In this example, the concentration degree determination device 2 can output the necessary instruction signal after the elapse of the second time. Even if the vehicle 1 is running on the second road in order to maintain the driving safety, the driver needs to maintain the driving concentration degree such that the driving concentration degree satisfies the second-road reference. The driver can recognize the decrease in driving concentration degree by the warning, and enhance the driving concentration degree. Thus, the driving safety is maintained in the case that the vehicle 1 is running on the second road. The warning is necessary for the driver whose driving concentration degree does not continuously satisfy the second-road reference during the second time. The driver does not receive the excessive warning in the case that the vehicle 1 is running on the second road, so that the driver can comfortably maintain the state of concentrating on the driving.

The length of the second time selected in step S110 of FIG. 4 may be a fixed value or a variation irrespective of the index used to estimate the driving concentration degree. In the case that the length of the second time is the variation, for example, the signal output unit 2318 may change the length of the second time according to the index used to estimate the driving concentration degree. For example, the signal output unit 2318 may refer to a table associating each index stored in the storage unit 22 with the length of the second time.

The degree of urgency of the warning depends on the index used to estimate the driving concentration degree. For example, the sleepiness is an index having the higher degree of urgency of the warning than that of the putting-on and taking-off of the glasses or sunglasses. Depending on a degree of the sleepiness, there is a higher possibility of influencing the driving safety as compared with the putting-on and taking-off of the glasses or sunglasses in the case that the vehicle 1 is running on the second road. For this reason, in the case that the driving concentration degree in which the sleepiness is set to the index does not satisfy the second-road reference, preferably the concentration degree determination device 2 outputs the instruction signal more quickly than the case that the driving concentration degree in which the putting-on and taking-off of the glasses or sunglasses are set to the index does not satisfy the second-road reference.

In this example, the concentration degree determination device 2 can output the instruction signal at a speed corresponding to the degree of urgency of the warning for each index. The driver can receive the warning in proper timing, so that the driver can maintain the state suitable for the manual driving.

Even if the length of the first time selected in step S106 may be a fixed value irrespective of the index used to estimate the driving concentration degree or a variation corresponding to the index used to estimate the driving concentration degree for the same reason as the second time. In the case that the length of the first time is the variation, for example, the signal output unit 2318 may change the length of the first time according to the index used to estimate the driving concentration degree. For example, the signal output unit 2318 may refer to a table associating each index stored in the storage unit 22 with the length of the first time.

In the embodiment, the concentration degree determination device 2 detects the state of the driver using the driver image data captured by the driver camera 15 as monitoring data, and estimates the driving concentration degree. However, the monitoring data is not limited to the driver image data. For example, the monitoring data may be biological data obtained by a biosensor that monitors the driver of the vehicle 1. For example, the biosensor is a pulse wave sensor or a heart beat sensor. The biosensor is not limited to the pulse wave sensor or the heart beat sensor as long as biosensor can monitor the driver. The biosensor may be a contact type sensor or a non-contact type sensor. The concentration degree determination device 2 can detect the state of the driver from the biological data. For example, the state of the driver detected from the biological data is an index such as a pulse wave or a heart beat.

For example, the monitoring data may be data obtained by a sensor that is installed in the steering wheel 5 to measure strength of the driver who grasps the steering wheel 5.

In short, the present invention is not limited to the above embodiment, and constituent elements can be modified and embodied in the implementation stage without departing from the gist thereof. Various inventions can be made by appropriately combining a plurality of constituent elements disclosed in the above embodiment. For example, some constituent elements may be deleted from all the constituent elements illustrated in the embodiment. Constituent elements over different embodiments may appropriately be combined.

The embodiment may be implemented by a storage medium such as a read only memory (ROM) that stores a program causing the processor 231 to execute processing of each unit included in the processor 231.

A part or all of the above embodiment may also be described as follows, but is not limited to the following.

### (Supplementary Note 1)

A concentration degree determination device including:

a processor configured to acquire monitoring data from a sensor that monitors a driver of a vehicle,

to estimate a driving concentration degree of the driver from the monitoring data;

to compare the driving concentration degree to a first-road reference when the vehicle is running on a first road, and to compare the driving concentration degree to a second-road reference when the vehicle is running on a second road having a road environment different from a road environment of the first road, and

to output an instruction signal issuing an instruction to perform support to the driver after elapse of a first time when the driving concentration degree does not satisfy the first-road reference during running of the vehicle on the first road, and to output the instruction signal after elapse of a second time shorter than the first time when the driving concentration degree does not satisfy the second-road reference during running of the vehicle on the second road; and

a memory that stores an instruction operating the processor.

### (Supplementary Note 2)

A concentration degree determination method including:

a monitoring data acquisition step of acquiring monitoring data from a sensor that monitors a driver of a vehicle using at least one processor;

a concentration degree estimating step of estimating a driving concentration degree of the driver from the monitoring data using the at least one processor;

a reference comparing step of comparing the driving concentration degree to a first-road reference when the vehicle is running on a first road using the at least one processor, and of comparing the driving concentration degree to a second-road reference when the vehicle is running on a second road having a road environment different from a road environment of the first road using the at least one processor; and

a signal output step of outputting an instruction signal issuing an instruction to perform support to the driver after elapse of a first time when the driving concentration degree does not satisfy the first-road reference during running of the vehicle on the first road using the at least one processor, and of outputting the instruction signal after elapse of a second time shorter than the first time when the driving concentration degree does not satisfy the second-road reference during running of the vehicle on the second road using the at least one processor.

1. A concentration degree determination device comprising:
a processor configured with a program to perform operations comprising:
operation as a monitoring data acquisition unit configured to acquire monitoring data from a sensor that monitors a driver of a vehicle;
operation as a concentration degree estimator configured to estimate a driving concentration degree of the driver from the monitoring data;
operation as a reference comparator configured to compare the driving concentration degree to a first-road reference in response to the vehicle running on a first road, and to compare the driving concentration degree to a second-road reference in response to the vehicle running on a second road having a road environment different from a road environment of the first road; and
operation as a signal output unit configured to:
output an instruction signal issuing an instruction to perform support to the driver after elapse of a first time in response to the driving concentration degree not satisfying the first-road reference during running of the vehicle on the first road,
output the instruction signal after elapse of a second time shorter than the first time in response to the driving concentration degree not satisfying the second-road reference during running of the vehicle on the second road, and
change at least one of a length of the first time and a length of the second time according to an index included in a state of the driver, the index being used to estimate the driving concentration degree.

2. The concentration degree determination device according to claim 1, wherein the first road is an expressway and the second road is an ordinary road.

3. The concentration degree determination device according to claim 1, wherein the processor is configured with the program such that operation as the concentration degree estimator comprises operation as the concentration degree estimator estimating the driving concentration degree with at least one of sleepiness and looking aside of the driver as the index.

4. (canceled)

5. The concentration degree determination device according to claim 1, wherein the processor is configured with the program to perform operations such that operation as the signal output unit comprises operation as the signal output unit that performs at least one of:
not outputting the instruction signal in response to the driving concentration degree satisfying the first-road reference within the first time even if the driving concentration degree is determined not to satisfy the first-road reference during the running of the vehicle on the first road; and
not outputting the instruction signal in response to the driving concentration degree satisfying the second-road reference within the second time even if the driving concentration degree is determined not to satisfy the second-road reference during the running of the vehicle on the second road.

6. A concentration degree determination method comprising:
acquiring monitoring data from a sensor that monitors a driver of a vehicle;
estimating a driving concentration degree of the driver from the monitoring data;
comparing the driving concentration degree to a first-road reference in response to the vehicle running on a first road, and of comparing the driving concentration degree to a second-road reference in response to the vehicle running on a second road having a road environment different from a road environment of the first road;
outputting an instruction signal issuing an instruction to perform support to the driver after elapse of a first time in response to the driving concentration degree not satisfying the first-road reference during running of the vehicle on the first road;
outputting the instruction signal after elapse of a second time shorter than the first time in response to the driving concentration degree not satisfying the second-road reference during running of the vehicle on the second road; and
changing at least one of a length of the first time and a length of the second time according to an index included in a state of the driver, the index being used to estimate the driving concentration degree.

7. A non-transitory computer-readable storage medium storing a program for determining concentration degree, the program, which when read and executed, causes a computer to perform operations comprising operations of the concentration degree determination device according to claim 1.

8. The concentration degree determination device according to claim 2, wherein the processor is configured with the program such that operation as the concentration degree estimator comprises operation as the concentration degree estimator that estimates the driving concentration degree with at least one of sleepiness and looking aside of the driver as the index.

9. A non-transitory computer-readable storage medium storing a program for determining concentration degree, the program, which when read and executed, causes a computer to perform operations comprising operations of the concentration degree determination device according to claim 8.

10. The concentration degree determination device according to claim 2, wherein the processor is configured with the program such that operation as the signal output unit comprises operation as the signal output unit that performs at least one of:
not outputting the instruction signal in response to the driving concentration degree satisfying the first-road reference within the first time even if the driving concentration degree is determined not to satisfy the first-road reference during the running of the vehicle on the first road, and
not outputting the instruction signal in response to the driving concentration degree satisfying the second-road reference within the second time even if the driving concentration degree is determined not to satisfy the second-road reference during the running of the vehicle on the second road.

11. A non-transitory computer-readable storage medium storing a program for determining concentration degree, the program, which when read and executed, causes a computer to perform operations comprising operations of the concentration degree determination device according to claim 10.

12. The concentration degree determination device according to claim 3, wherein the processor is configured with the program such that operation as the output signal unit comprises operation as the signal output unit that performs at least one of:
not outputting the instruction signal in response to the driving concentration degree satisfying the first-road reference within the first time even if the driving concentration degree is determined not to satisfy the first-road reference during the running of the vehicle on the first road, and
not outputting the instruction signal in response to the driving concentration degree satisfying the second-road reference within the second time even if the driving concentration degree is determined not to satisfy the second-road reference during the running of the vehicle on the second road.

13. A non-transitory computer-readable storage medium storing a program for determining concentration degree, the program, which when read and executed, causes a computer to perform operations comprising operations of the concentration degree determination device according to claim 12.

14. A non-transitory computer-readable storage medium storing a program for determining concentration degree, the program, which when read and executed, causes a computer to perform operations comprising operations of the concentration degree determination device according to claim 2.

15. A non-transitory computer-readable storage medium storing a program for determining concentration degree, the program, which when read and executed, causes a computer to perform operations comprising operations of the concentration degree determination device according to claim 3.

16. A non-transitory computer-readable storage medium storing a program for determining concentration degree, the program, which when read and executed, causes a computer to perform operations comprising operations of the concentration degree determination device according to claim 5.
